(19) United States
(12) Patent Application Publication
(10) Pub. No.: US 2026/0237000 A1
(43) Pub. Date: Aug. 13, 2026

(54) Blockchain-Based Taxation and Disbursement System

(71) Applicant: Adam Denoto, Brook Park, OH (US)

(72) Inventor: Adam Denoto, Brook Park, OH (US)

(21) Appl. No.: 19/321,522

(22) Filed: Sep. 8, 2025

Related U.S. Application Data
(60) Provisional application No. 63/756,325, filed on Feb. 10, 2025.

(51) Int. Cl. G06Q 40/12; G06Q 20/02; G06Q 20/06; G06Q 20/38; H04L 9/40

(52) U.S. Cl. CPC G06Q 40/123; G06Q 20/027; G06Q 20/0658; G06Q 20/389; H04L 63/1458; H04L 63/1483

(57) ABSTRACT

A blockchain-based taxation and disbursement system for converting taxpayer payments into standardized blockchain-based tax tokens on a secure, government-operated blockchain network is disclosed. The system includes a plurality of distributed blockchain nodes configured to execute smart contracts comprising a tax token smart contract, a treasury vault smart contract, an appropriation registry, and a disbursement streams smart contract. A payment gateway receives taxpayer payments, triggers token minting, and records transactions immutably across the blockchain. The treasury vault stores tokens for allocation to appropriations and controlled disbursements to approved recipients in accordance with time-based or milestone-based conditions. A compliance module enforces KYC/AML and sanctions checks before disbursement. Vendors can redeem tokens for fiat currency via authorized redemption channels. An investment manager smart contract monitors idle vault balances and invests in whitelisted, low-risk blockchain-based financial instruments, returning yield to the treasury vault.

### CROSS-REFERENCE TO RELATED APPLICATION

The present application claims priority to, and the benefit of, U.S. Provisional Application No. 63/756,325 which was filed on Feb. 10, 2025 and is incorporated herein by reference in its entirety.

### FIELD OF THE INVENTION

The present invention generally relates to government revenue collection and fiscal management systems. More specifically, the present invention relates to a blockchain-based taxation and disbursement system configured to convert taxpayer payments into standardized blockchain-based tax tokens and to manage the allocation, disbursement, and investment of such tokens in a secure, transparent, and auditable manner. The invention comprises a secure blockchain network including a plurality of distributed blockchain nodes, each storing a replicated ledger and executing smart contracts for tax token issuance, treasury vault custody, appropriation registry maintenance, and programmable disbursement streams. Accordingly, the present disclosure makes specific reference thereto. Nonetheless, it is to be appreciated that aspects of the present invention are also equally applicable to other like applications, devices, and methods of manufacture.

### BACKGROUND

By way of background, governmental departments such as the internal revenue service (IRS) and legislative bodies, for example Congress, are entrusted with the collection, allocation, and expenditure of taxpayer funds. However, there have been longstanding concerns regarding the mismanagement of the funds, which can contribute to inflationary pressures, national debt growth, and broader financial instability. In certain instances, government officials may opt for salary increases for themselves without adequate public disclosure or oversight. Additionally, significant amounts of taxpayer money may be allocated to projects that provide little or no direct benefit to the public, resulting in waste and inefficiency.

At present, there is no universally adopted system that provides real-time, public transparency over how tax revenues are collected, allocated, and spent. The absence of such a mechanism limits the ability of citizens, auditors, and oversight bodies to hold elected representatives and government agencies accountable for fiscal decisions. The lack of accountability undermines public trust in governmental financial management and creates an environment where mismanagement can occur without immediate detection or corrective action.

Therefore, there exists a long-felt need in the art for a taxation and disbursement system that provides transparency, accountability, and real-time auditability of government revenue collection and spending. There is a longstanding need for a system that converts taxpayer payments into standardized blockchain-based tokens. Additionally, there is a need for a blockchain-based taxation and disbursement system that can maintain a record of transactions, especially those made in a cryptocurrency, across computers that are linked in a peer-to-peer network. Further, there is a need in the art for a system that makes government spending transparent, accountable, and auditable in real-time, preventing waste and fiscal mismanagement. Additionally, there is a need for a system that enables the tax tokens to be decentralized and standardized with the ability to be re-invested on the blockchain. Furthermore, there exists a need for a system that reinvests idle balances into low-risk, whitelisted blockchain-based financial instruments to generate yield for the public benefit. Finally, there is a need for a solution that actively deters fiscal mismanagement and restores public trust in government financial operations.

The subject matter disclosed and claimed herein, in one embodiment, comprises a blockchain-based taxation and disbursement system configured to operate over a secure, government-administered blockchain network. The system includes a plurality of distributed blockchain nodes, each storing a full replicated ledger and executing smart contracts comprising a tax token contract, a treasury vault contract, an appropriation registry, and a disbursement streams contract. A payment gateway receives taxpayer payments and triggers the tax token contract to mint blockchain-based tax tokens equivalent to the payment value. The treasury vault contract securely stores the tokens and releases them only upon authorization linked to appropriations recorded in the appropriation registry. The disbursement streams contract enables controlled release of tokens to approved recipients according to time-based or milestone-based criteria, ensuring that all transactions are permanently recorded and auditable in real time.

In one embodiment, the system includes a compliance module that automatically performs identity verification, anti-money laundering checks, know-your-customer checks, and sanctions list screening before tokens are disbursed to a vendor. In another embodiment, an investment manager smart contract monitors idle token balances in the treasury vault and allocates them into pre-approved, low-risk blockchain-based assets such as tokenized U.S. Treasury securities or repurchase agreements.

In this manner, the blockchain-based taxation and disbursement system of the present invention addresses longstanding shortcomings in traditional government financial management by enabling full-cycle transparency, on-chain accountability, and efficient reinvestment of idle funds. The invention enables taxpayers, auditors, and oversight bodies to verify every stage of the taxation lifecycle, from collection to disbursement and reinvestment, through a single, immutable ledger. The system integrates programmable smart contracts, compliance automation, and secure blockchain infrastructure to provide a tamper-resistant platform that improves fiscal discipline, deters misuse of public funds, and enhances trust between the government and its citizens.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a blockchain-based taxation and disbursement system. The system comprises a secure blockchain network that includes a plurality of distributed blockchain nodes. Each blockchain node stores a replicated ledger and is configured to execute a plurality of smart contracts including a tax token smart contract, a treasury vault smart contract, an appropriation registry smart contract, and a disbursement streams smart contract. The system further includes a payment gateway that receives payment from a taxpayer and transmits transaction data to the blockchain network.

The tax token smart contract mints a plurality of blockchain-based tax tokens in response to a confirmed payment, where each tax token represents a fixed unit of value equivalent to a fiat currency amount. The treasury vault smart contract stores the blockchain-based tax tokens and releases the tax tokens only pursuant to disbursement authorizations linked to budget appropriations recorded in the appropriation registry smart contract. The disbursement streams smart contract transfers the tax tokens from the treasury vault to an approved recipient in accordance with at least one of a time-based schedule and a milestone-based condition, and all transactions are recorded immutably on the replicated ledger for real-time public auditability.

In one embodiment, a computer-implemented method for converting taxpayer payments into blockchain-based tax tokens is disclosed and includes receiving, via a payment gateway, a payment from a taxpayer and verifying the authenticity and settlement of the payment. The method further includes executing, by a blockchain node, a tax token smart contract to mint a number of blockchain-based tax tokens corresponding to the payment amount. The minted blockchain-based tax tokens are deposited into a treasury vault smart contract on the blockchain, where the treasury vault smart contract is configured to securely store the tax tokens for subsequent allocation to appropriations and disbursements. The minting and depositing steps are recorded immutably across a plurality of blockchain nodes in the blockchain network, thereby ensuring transparency and auditability.

In yet another embodiment, a blockchain-based investment management system for idle taxpayer funds is disclosed and includes a treasury vault smart contract configured to store blockchain-based tax tokens. The system further includes an investment manager smart contract that monitors the balance of the treasury vault smart contract, identifies an idle portion of the balance not required for immediate disbursements, and transfers the idle portion into one or more whitelisted low-risk blockchain-based financial instruments selected from the group consisting of tokenized government treasury securities and tokenized repurchase agreements. Any yield generated from one or more financial instruments is returned to the treasury vault smart contract, and all investment and yield transactions are immutably recorded on the blockchain.

In still another embodiment, each blockchain node is further configured with a processor and a high-speed storage device providing fast read and write access for state database and transaction indexing.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram view of the blockchain-based taxation and disbursement system of the present invention in accordance with the disclosed structure;

FIG. 2 illustrates the internal configuration of a representative blockchain node within the taxation and disbursement system of the present invention in accordance with the disclosed architecture;

FIG. 3 illustrates a flow diagram depicting operations for converting payment from a taxpayer into blockchain-based tax tokens in accordance with the disclosed architecture;

FIG. 4 illustrates a flow diagram showing an exemplary process for defining, allocating, and publicly recording government appropriations within the blockchain-based taxation and disbursement system of the present invention in accordance with the disclosed architecture; and

FIG. 5 illustrates a flow diagram showing an exemplary process for detecting unused balances in the treasury vault for deployment into approved, low-risk blockchain-based investment vehicles in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a taxation and disbursement system that provides transparency, accountability, and real-time auditability of government revenue collection and spending. There is a longstanding need for a system that converts taxpayer payments into standardized blockchain-based tokens. Further, there is a need in the art for a system that makes government spending transparent, accountable, and auditable in real-time, preventing waste and fiscal mismanagement. Additionally, there is a need for a system that enables the tax tokens to be decentralized and standardized with the ability to be re-invested on the blockchain. Furthermore, there exists a need for a system that reinvests idle balances into low-risk, whitelisted blockchain-based financial instruments to generate yield for the public benefit. Finally, there is a need for a solution that actively deters fiscal mismanagement and restores public trust in government financial operations.

The present invention, in one exemplary embodiment, is a blockchain-based investment management system for idle taxpayer funds and includes a treasury vault smart contract configured to store blockchain-based tax tokens. The system further includes an investment manager smart contract that monitors the balance of the treasury vault smart contract, identifies an idle portion of the balance not required for immediate disbursements, and transfers the idle portion into one or more whitelisted low-risk blockchain-based financial instruments selected from the group consisting of tokenized government treasury securities and tokenized repurchase agreements. Any yield generated from one or more financial instruments is returned to the treasury vault smart contract, and all investment and yield transactions are immutably recorded on the blockchain.

Reference will now be made in detail to the present preferred embodiments of the invention, examples of which are illustrated in the accompanying drawings. Wherever possible, the same reference numerals are used in the drawings and the description to refer to the same or like parts.

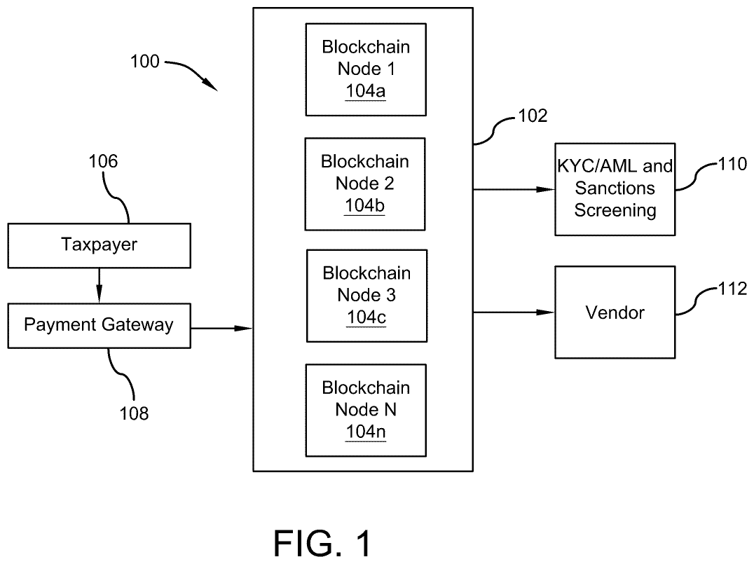

Referring initially to the drawings, FIG. 1 illustrates a block diagram view of the blockchain-based taxation and disbursement system of the present invention in accordance with the disclosed structure. The blockchain-based taxation and disbursement system 100 of the present invention is designed as a blockchain-based system for transforming the taxation process such as United States IRS taxation process into a transparent, accountable, and auditable framework. More specifically, the blockchain-based taxation and disbursement system 100 converts tax payments from citizens and businesses into standardized blockchain based tokens such as Ethereum based Tax Tokens (i.e., ERC-20 token) on a secure, government-operated blockchain network. The tokens can be allocated through on-chain appropriations and allotments, disbursed to agencies and vendors via programmable smart contracts, and recorded immutably for real-time public oversight.

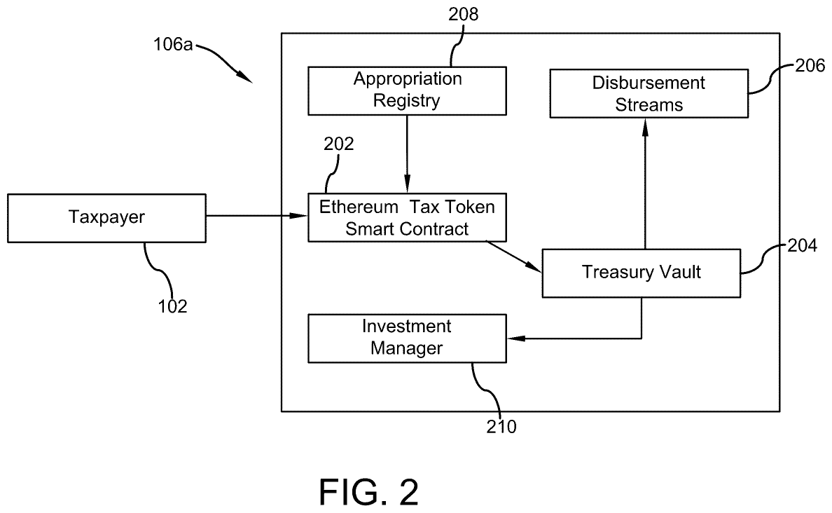

The blockchain-based taxation and disbursement system 100 includes a secure blockchain network 102 which includes a plurality of distributed blockchain nodes 104a-n. Each blockchain node of the plurality of blockchain nodes 104a-n contains the full replicated ledger of the system 100 and is configured to execute smart contracts including, but not limited to, the ERC-20 token contract, treasury vault contract, appropriation registry, and disbursement stream logic as described in FIG. 2.

Each blockchain node provides attack mitigation by offering phishing protection such as DDoS protection and encrypted communication such as TLS 1.3 encrypted communication. The blockchain nodes can be deployed across a plurality of government datacenters in the trusted secure blockchain network 102. Each blockchain node can include a processor such as 8-core server-grade processor and a storage providing fast read/write for state database and transaction indexing.

A taxpayer 106 can initiate a tax payment through an authorized payment gateway 108 such as an electronic payment portal, an automated clearing house (ACH) transfer, or equivalent to interact with the blockchain network 102. The payment is transformed into a crypto token and is digitally recorded and associated with the identity of the taxpayer in compliance with security regulations of the system 100.

A KYC/AML and sanctions screening module 110 is configured in the system 100 for compliance and the module 110 validates vendor or recipient eligibility of the tax tokens under sanction lists such as know-your-customer (KYC), anti-money laundering (AML), and office of foreign assets control (OFAC) or more. The module 110 authorizes or rejects the participation of the users in the system 100 based on the eligibility checks.

A plurality of vendors 112 are configured to receive funds in the system 100 configured as crypto tokens such as Ethereum tax tokens, through disbursements initiated on the blockchain. Vendors can redeem these tokens for fiat currency via authorized redemption channels. The flow from blockchain nodes to vendors includes full on-chain traceability, ensuring transparent auditability of disbursements.

FIG. 2 illustrates the internal configuration of a representative blockchain node 106a within the taxation and disbursement system of the present invention in accordance with the disclosed architecture. The taxpayer 106 initiates a payment event such as income tax, corporate tax, excise tax through the authorized collection channel or gateway (as described in FIG. 1). The transaction data of the taxpayer is recorded on-chain and triggers the Ethereum tax token smart contract 202. The Ethereum tax token smart contract 202 mints a corresponding number of Ethereum tax tokens (i.e., ERC-20 standardization coins) on the Ethereum blockchain based on the payment amount received from the taxpayer 106. The smart contract 202 serves as the on-chain ledger and transaction logic for Ethereum tax tokens and is configured to mint tokens upon confirmed tax payments.

The Ethereum tax token smart contract 202 transfers tokens into the treasury vault 204 for storage. The treasury vault contract 204 functions as the primary on-chain custody module and holds the tax tokens. The treasury vault contract 204 disburses one or more tokens from the stored tokens through a disbursement streams contract 206 to agencies/vendors (FIG. 1). The disbursement streams contract 206 is used for controlled, auditable release of the tokens to recipients such as vendors and can be time-based such as daily, weekly, monthly, or more. The release of tokens can also be milestone-based such on a vendor completing a workorder. The disbursement process links directly to the appropriation registry 208 to ensure that funds are used solely for approved purposes.

The appropriation registry 208 records authorized budget allocations in the form of a plurality of records, wherein each record includes at least appropriation amount and purpose, and authorized agencies and programs. An investment manager module 210 regulates the reinvestment of idle Ethereum tax tokens from the treasury vault contract 204 into a plurality of whitelisted, low-risk, blockchain-based financial instruments such as tokenized government treasury securities.

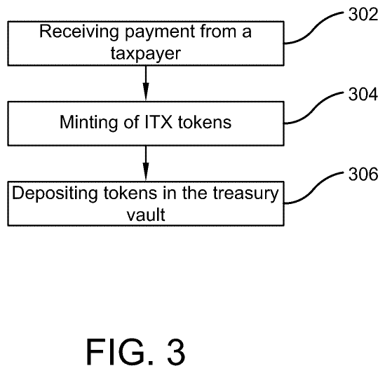

FIG. 3 illustrates a flow diagram depicting operations for converting payment from a taxpayer into blockchain-based tax tokens in accordance with the disclosed architecture. Initially, the system 100 receives a payment from a taxpayer through an authorized collection method such as ACH transfer, credit/debit card transaction, or wire transfer (Step 302). The payment data can be validated for authenticity, compliance, and settlement confirmation before initiating any on-chain processes.

Following payment confirmation, in the next step, the tax token smart contract mints a corresponding number of tax tokens (Step 304). Each token represents a fixed unit of value equivalent to U.S. dollars collected, thus enabling direct one-to-one tracking of tax funds on the blockchain. Minting events are recorded immutably across all the blockchain nodes for transparency and auditability.

Finally, the minted tax tokens (i.e., IRS tokens) are deposited into the treasury vault smart contract (Step 306). The vault functions as the on-chain custodial account for government tax holdings, preventing unauthorized spending or transfer. Tokens in the vault can later be allocated to appropriations, disbursement streams, or investment activities under policy-defined constraints as described in FIG. 2.

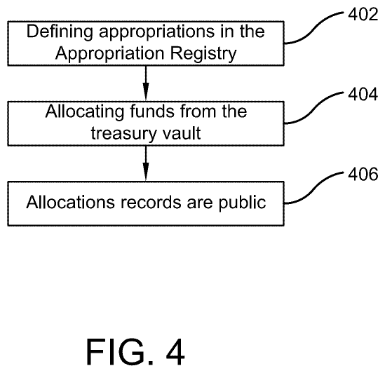

FIG. 4 illustrates a flow diagram showing an exemplary process for defining, allocating, and publicly recording government appropriations within the blockchain-based taxation and disbursement system of the present invention in accordance with the disclosed architecture. Initially, one or more authorized entities such as a treasury department define budget appropriations within the on-chain appropriation registry smart contract (Step 402). Each appropriation entry may specify the funding amount, purpose code, fiscal year, and any restrictions or conditions associated with the appropriation entry. Each appropriation record is a permanent, tamper-proof element of the blockchain ledger.

Then, based on the appropriations recorded in the appropriation registry smart contract, a corresponding amount of tax tokens from the treasury vault are allocated to specific allotment contracts or agency-controlled vendors/program accounts (Step 404). The allocations are governed by the rules and constraints set in the appropriation registry for compliance with statutory spending limits and authorized purposes.

Finally, all the fund allocations are recorded on the blockchain to make the records permanently available for real-time public inspection (Step 406). The blockchain environment enables taxpayers, auditors, and oversight bodies to verify the exact distribution of funds from the treasury vault to their agencies and programs.

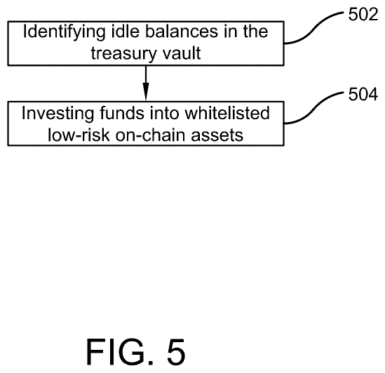

FIG. 5 illustrates a flow diagram showing an exemplary process for detecting unused balances in the treasury vault for deployment into approved, low-risk blockchain-based investment vehicles in accordance with one embodiment of the present invention. The system 100 is configured to continuously monitor the treasury vault smart contract to determine the portion of tax token holdings not required for immediate disbursements to vendors (Step 502). The evaluation may be based on budgetary schedules, payment calendars, and real-time agency drawdown rates.

In the next step, the identified idle balances are transferred under the control of the investment manager smart contract into whitelisted, low-risk on-chain financial instruments (Step 504). The financial instruments may include tokenized U.S. treasury bills, overnight repurchase agreements, or other blockchain-native representations of government-backed securities.

It should be noted that any yield generated from the idle balance investments is returned to the treasury vault, where the yield can be used to offset deficits, reduce tax burdens, or increase available funds for future appropriations.

In some embodiments, a vendor may initiate a disbursement request based on an active contract, grant, or procurement agreement with the vendor. Wallet address of the vendor is checked against KYC/AML and sanctions screening records before transferring the tokens. Upon successful compliance verification, the treasury vault releases the allocated tax tokens to the vendor's approved blockchain wallet.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “blockchain-based taxation and disbursement system”, “taxation and disbursement system”, and “system” are interchangeable and refer to the blockchain-based taxation and disbursement system 100 of the present invention.

Notwithstanding the forgoing, the blockchain-based taxation and disbursement system 100 of the present invention can be of any suitable configuration as is known in the art without affecting the overall concept of the invention, provided that it accomplishes the above stated objectives. One of ordinary skill in the art will appreciate that the blockchain-based taxation and disbursement system 100 as shown in the FIGS. are for illustrative purposes only, and that many other configurations of the blockchain-based taxation and disbursement system 100 are well within the scope of the present disclosure. Although the dimensions of the blockchain-based taxation and disbursement system 100 are important design parameters for user convenience, the blockchain-based taxation and disbursement system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for a blockchain-based taxation and disbursement system for transforming the taxation process, the method comprising the steps of:
providing a taxation process, tax payments, blockchain based tokens, a blockchain network, a taxpayer, a payment gateway and a plurality of vendors;
initiating said tax payments by said taxpayer through said payment gateway, wherein said payment gateway selected from the group consisting of an electronic payment portal, an ACH transfer, a credit/debit card transaction, and a wire transfer;
converting said tax payments into said blockchain based tokens, wherein said blockchain based tokens selected from the group consisting of a crypto token, an Ethereum based Tax Token, and an ERC-20 token;
allocating said blockchain based tokens through on-chain appropriations and allotments, wherein said blockchain network comprises a plurality of blockchain nodes and further wherein each blockchain node of said plurality of blockchain nodes comprises a replicated ledger of the blockchain-based taxation and disbursement system;
executing a contract selected from the group consisting of an ERC-20 token contract, a treasury vault contract, an appropriation registry contract, and a disbursement stream logic contract, wherein each said blockchain node comprises attack mitigation including phishing protection selected from the group consisting of DDoS protection and TLS 1.3 encrypted communication; and
digitally recording said tax payments to an associated identity of said taxpayer.

2. The method for a blockchain-based taxation and disbursement system of claim 1 further comprising a step of conducting an eligibility check with a screening module comprising sanction lists selected from the group consisting of know-your-customer (KYC), anti-money laundering (AML), and office of foreign assets control (OFAC), wherein said screening module is configured in the blockchain-based taxation and disbursement system to validate vendor and recipient eligibility of said blockchain based tokens.

3. The method for a blockchain-based taxation and disbursement system of claim 2, wherein said plurality of vendors are configured to receive funds in the blockchain-based taxation and disbursement system configured as said blockchain based tokens.

4. The method for a blockchain-based taxation and disbursement system of claim 3, wherein said plurality of vendors redeem said blockchain based tokens for fiat currency through an authorized redemption channel.

5. The method for a blockchain-based taxation and disbursement system of claim 4, wherein said tax payments are made through said payment gateway and are selected from the group consisting of income tax, corporate tax, and excise tax.

6. The method for a blockchain-based taxation and disbursement system of claim 5, wherein said transaction data of said taxpayer is recorded on-chain and triggers a Ethereum tax token contract, and further wherein said Ethereum tax token contract mints a corresponding number of said blockchain based tokens corresponding to said tax payments received from said taxpayer.

7. The method for a blockchain-based taxation and disbursement system of claim 6, wherein said blockchain network is a government-operated blockchain network, and further wherein said taxation process comprises a United States IRS taxation process.

8. The method for a blockchain-based taxation and disbursement system of claim 7, wherein said Ethereum tax token contract transfers said blockchain based tokens into a treasury vault.

9. The method for a blockchain-based taxation and disbursement system of claim 8, wherein said treasury vault stores said blockchain based tokens and selectively disburses one or more said blockchain based tokens from the stored said blockchain based tokens to a selected one of said plurality of vendors, and further wherein selectively disbursing is time-based selected from the group consisting of daily, weekly, and monthly.

10. A method for a blockchain-based taxation and disbursement system for transforming the taxation process, the method comprising the steps of:
providing a taxation process, tax payments, blockchain based tokens, a blockchain network, a taxpayer, a payment gateway, a plurality of vendors;
receiving said tax payments by said taxpayer through said payment gateway, wherein said payment gateway selected from the group consisting of an electronic payment portal, an ACH transfer, a credit/debit card transaction, and a wire transfer;
validating said tax payments;
converting said tax payments into said blockchain based tokens, wherein each of said blockchain based tokens represent a fixed unit of value equivalent to U.S. dollars; and
depositing said blockchain based tokens into a treasury vault.

11. The method for a blockchain-based taxation and disbursement system of claim 10 further comprising a step of allocating said blockchain based tokens through on-chain appropriations and allotments.

12. The method for a blockchain-based taxation and disbursement system of claim 11, wherein said blockchain network comprises a plurality of blockchain nodes, and further wherein each blockchain node of said plurality of blockchain nodes comprises a replicated ledger of the blockchain-based taxation and disbursement system.

13. The method for a blockchain-based taxation and disbursement system of claim 11 further comprising a step of executing a contract selected from the group consisting of an ERC-20 token contract, a treasury vault contract, an appropriation registry contract, and a disbursement stream logic contract.

14. The method for a blockchain-based taxation and disbursement system of claim 13, wherein each said blockchain node comprises attack mitigation including phishing protection selected from the group consisting of DDoS protection and TLS 1.3 encrypted communication.

15. The method for a blockchain-based taxation and disbursement system of claim 14 further comprising a step of digitally recording said tax payments to an associated identity of said taxpayer.

16. A method for a blockchain-based taxation and disbursement system for transforming the taxation process, the method comprising the steps of:
providing a taxation process, tax payments, blockchain based tokens, a blockchain network, a taxpayer, a payment gateway, a plurality of vendors;
receiving said tax payments by said taxpayer through said payment gateway, wherein said payment gateway selected from the group consisting of an electronic payment portal, an ACH transfer, a credit/debit card transaction, and a wire transfer;
validating said tax payments;
converting said tax payments into said blockchain based tokens, wherein each of said blockchain based tokens represent a fixed unit of value equivalent to U.S. dollars;
depositing said blockchain based tokens into a treasury vault;
detecting unused idle balances in said treasury vault; and
deploying said unused idle balances into a blockchain-based investment.

17. The method for a blockchain-based taxation and disbursement system of claim 16, wherein said blockchain-based investment selected from the group consisting of tokenized U.S. treasury bills, overnight repurchase agreements, and blockchain-native representations of government-backed securities.

18. The method for a blockchain-based taxation and disbursement system of claim 16 further comprising a step of allocating said blockchain based tokens through on-chain appropriations and allotments.

19. The method for a blockchain-based taxation and disbursement system of claim 16 further comprising a step of executing a contract selected from the group consisting of an ERC-20 token contract, a treasury vault contract, an appropriation registry contract, and a disbursement stream logic contract.

20. The method for a blockchain-based taxation and disbursement system of claim 16 further comprising a step of digitally recording said tax payments to an associated identity of said taxpayer.
